(19) United States
(12) Patent Application Publication
(10) Pub. No.: US 2013/0138656 A1
(43) Pub. Date: May 30, 2013

(54) Method and Device for Expiration Date Weighted Food Inventory System and Meal Planner

(71) Applicant: Wendi Wheaton, Glendale, AZ (US)

(72) Inventor: Wendi Wheaton, Glendale, AZ (US)

(21) Appl. No.: 13/657,856

(22) Filed: Oct. 22, 2012

Related U.S. Application Data
(60) Provisional application No. 61/629,129, filed on Nov. 14, 2011.

(51) Int. Cl. G06F 17/30

(52) U.S. Cl. CPC G06F 17/30705
USPC 707/740; 709/206; 709/219

(57) ABSTRACT

A method and device comprising a food inventory system that enables food inventory control as well as meal planning Food items are entered into a software controlled means for storing food inventory data and meal recipes. Meal planning is enabled whereby recipes are proposed based on inventory levels and/or food expiration or spoilage times, as well as nutrient and dietary information. Shopping lists are created that reflect inventory levels, recipe needs, and/or food expiration or spoilage dates.

### FIELD OF THE INVENTION

The present invention relates to food inventory systems for the purpose of meal preparation and inventory control. More specifically, the present invention relates to software controlled devices used to maintain a food inventory. More specifically, the present invention relates to a method for maintaining a food inventory with a weighted value placed on food expiration date or spoilage rates, for the purpose of providing recipes based on the inventory on hand as well as obtaining new inventory for a recipe and/or to maintain inventory levels.

### DESCRIPTION OF THE RELATED ART

The related art contains means for maintaining inventories of food stocks for commercial sales. The related art also contains meal planning systems based on calorie amounts or nutritional value. The prior art does not contain a method and device for personal use that maintains a food inventory based on foodstock levels and expiration or spoilage dates that also enables meal planning

### SUMMARY OF THE INVENTION

The present invention relates to a method and device for easily and accurately maintaining a food inventory and matching available inventory to recipes as a method of determining what meals can be prepared with current inventory on hand so as to both maintain a food supply and to avoid spoilage by the creation of software created lists that alert to the need to replace inventory as needed, and recipes that use food inventory before an anticipated expiration or spoilage date arrives.

A device capable of scanning and interpreting UPC bar code (Universal Product Code Bar Code) symbols is linked through a microprocessor to a data storage device containing current inventory levels, recipes for meals, and common food spoilage and expiration times. A device capable of accepting manually entered food inventory information, other information and commands is linked to the above microprocessor in order to enter information about inventory without a UPC bar code. A device capable of accepting voice interactive entered food inventory information, other information and commands is linked to the above microprocessor in order to enter information about inventory without a UPC bar code. Said device(s) include a display means capable of displaying food inventory and recipe information, and includes a keyboard means for interacting with said device and said display means. Said device may contain part or all of the food inventory database and recipe database local to the device or stored in another location.

By having an accurate inventory and knowing when a food inventory item will spoil or expire with the known inventory level, recipes are generated that use a food item before it expires or spoils. Removal of a food item that is not part of a recipe is entered manually or using voice interaction, however, choosing a recipe will reflect a decrease in foodstock level for those given ingredients in their respective foodstock levels. Similarly, proposed shopping lists are created based on expiration dates and inventory consumption and can be manually adjusted after initial shopping list generation. The final shopping list chosen is then accounted for in the foodstock levels as an increase in the foodstock level for those respective foodstock items or foodstock levels can be adjusted utilizing purchase data from merchants or through manual or voice interactive updates. Finally, at all times, those items in the food inventory that are about to expire or spoil are displayed in said display means in a constant display and/or as part of a proposed shopping list, and are highlighted, flashing, are in enlarged font, bolded, and/or are otherwise brought to attention by some other indicating means using display and/or sound, including sending a text to designated phones or email addresses.

It is therefore an object of the present invention to maintain a foodstock inventory in such a manner as to avoid food spoilage and to ensure an on hand supply of desired ingredients for particular recipes.

It is another object of the present invention to save money on food, by: food item expenditure by enabling a user to buy less food items and to buy only the food items needed; avoiding food spoilage; and making it easier to create a meal at home rather than going to a restaurant or ordering hot meals for delivery where inventory levels are displayable and recipes automatically generated.

It is another object of the present invention to maintain a food inventory by: manual entry of foodstock use and replacement; voice entry of foodstock use and replacement; bar code scanning of food items added or removed to the inventory, or image capture and processing of bar code information; recipe generation that results in a decrease in food inventory; and shopping list generation that results due to a decrease in food inventory.

The characteristics and utilities of the present invention described in this summary and the detailed description below are not all inclusive. Many additional features and advantages will be apparent to one of ordinary skill in the art given the following description. There has thus been outlined, rather broadly, the more important features of the invention in order that the detailed description thereof that follows may be better understood, and in order that the present contribution to the art may be better appreciated.

In this respect, by explaining at least one embodiment of the invention in detail, it is to be understood that the invention is not limited in its application to the details of construction and to the arrangements of the components set forth in the description. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the description be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, nor is it intended to be limiting as to the scope of the invention in any way.

The characteristics and utilities of the present invention described in this summary and the detailed description below are not all inclusive. Many additional features and advantages will be apparent to one of ordinary skill in the art given the following detailed description.

### BRIEF DESCRIPTION OF THE FIGURES & DRAWINGS

Figure One, shows how data entered is catalogued by the system, including food item entry and removal from inventory mode.

Figure Two, shows how data entered in the device processes the information to recommend items for purchase in shopping list generation mode.

Figure Three, shows meal planning and food expiration mode whereby expiration dates are tracked and meals are planned by the recommendation of recipes according to expiration of food items.

### DETAILED DESCRIPTION

In use, the present system operates in four modes: food item entry into inventory and removal from inventory; food expiration alerting, meal/menu planning, shopping list generation; and on demand meal preparation based on current inventory.

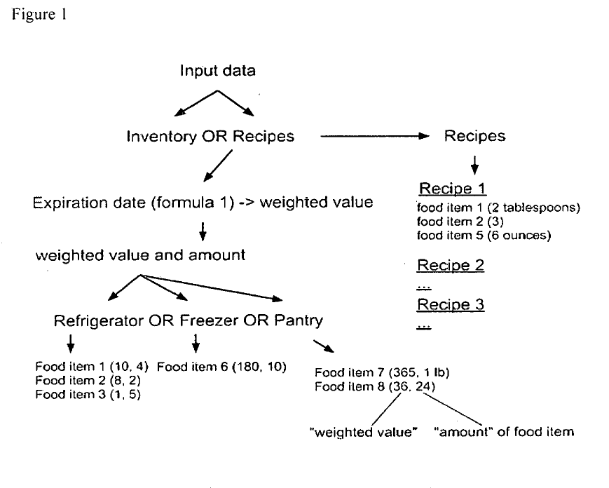

In the food item entry and removal mode, food items are placed into a food storage device or devices including refrigerator, freezer, and pantry. See FIG. 1. The inventory system is maintained by scanning a UPC code found on many food items or packaging available today or via manual entry or voice activated entry using a product number or descriptor such as “apple” and then quantity, as well as expiration date information, and other modes of automation such as image capture, sending the image to a remote server for image-processing based analysis with image processing software. As food items are placed into said food storage devices they become foodstocks as part of an inventory. They also are tagged in the database with information as to probable expiration. Alternatively, where the system has generated a shopping list, an increase in the foodstock levels for the items on the shopping list is shown as pending and then is permanently increased upon indicating to the system that said shopping list has been added to the food inventory (see shopping list generation mode below). It is also possible to link food purchases from merchants to a database to download purchase information to the device and associated probable expiration dates therefore fully automating inventory updates. As described herein raw data may be formatted by the merchant and sent to the user's device or a remote server where the data is formatted for inclusion into overall system and properly categorized according to the designs herein.

A data storage device stores inventory levels for all foodstocks and permits manual entry, bar code scanning, or voice entry of new food items as a foodstock type. Expiration dates are automatically entered from a UPC barcode, entered manually via a keyboard means, image capture and image processing, or are applied as a default from a data set that comprises typical food spoilage times. Said food spoilage data set can be altered by a user for any given food item. User can select which source of expiration or spoilage data to apply via said keyboard or voice interaction means and a display means attached electronically to a data storage device that stores inventory information and recipes. By entering an expiration date, via manual entry, voice, bar code, or image processing, or other means described herein, a value of days until expiration is calculated and associated (or “tagged”) with the food item. See “weighted value” in FIG. 1, for example. Alternatively a value for the days until expiration may be obtained by data sent from a merchant, or from a list of common spoilage times for a given food and stored in the database for reference by the system. Relatedly, at all times and/or as part of a proposed shopping list, soon to expire or spoil foods are displayed on said display means whereby an indicating means such as flashing are deployed to bring attention to said expiring or spoiling items. Reminders of soon to spoil food or shopping lists can be sent to email addresses or cell phones as text messages, and in certain embodiments along with suggested recipes that use the soon to expire food items, and are in order whereby recipes with soon to expire food items and all needed ingredients are in the inventory are given preference and noted in a list of suggested recipes. In other embodiments there is a possibility to set the device to automatic where it will automatically order food from merchants who choose to be tied into the broader system for ordering and foodstock pickup or delivery. Software on either a desktop computer or handheld device as listed herein, selects soon to expire or expired food items for automatic ordering with associated merchants. Automatic ordering is carried out by the software formatting the information of needed food items and sending over a network to the merchant.

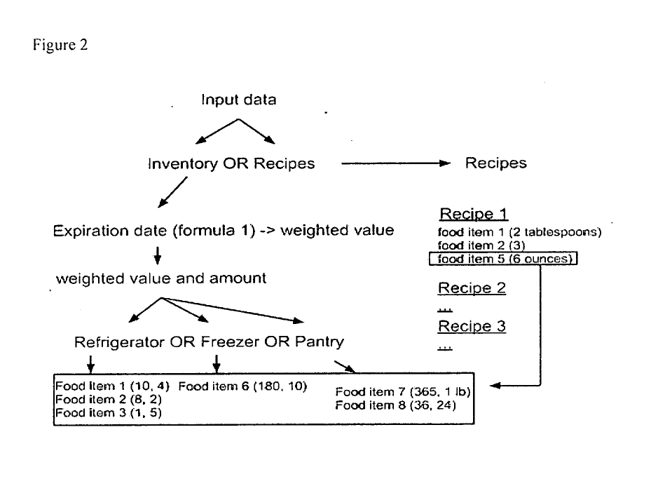

Shopping list generation mode comprises a means for generating a shopping list based on inventory level and expiration or spoilage values. As a foodstock level approaches zero or is at zero, or whose days to expiration value is at zero or below zero, that foodstock is placed on a proposed shopping list. As a foodstock approaches its expiration or spoilage date, that foodstock is placed on a proposed shopping list. Said shopping list is comprised of sublists consisting of: soon to expire foods or expired foods; foods needed for recipes; and foodstocks that are nearing zero or are at zero inventory level. In an alternative embodiment, one shopping list is created but food items are listed in different colors or otherwise are paired with alphanumeric or other indicators that describe why the food item is on the shopping list. By way of example, FIG. 2 outlines the association of a needed food item with its absence in the inventory. The software draws the association then outputs the result in the form of a shopping list. A user may enter recipe sets for a meal or several meals that may result in a negative inventory count and thereby also be indicated on a proposed shopping list (see below meal planning mode). A user is presented with a proposed shopping list that may be edited by a user. After returning home from purchasing desired items on a selected shopping list, a user confirms that all or some of the items on the shopping list are being added to the inventory, i.e., items are added to a user's food storage devices. Alternatively food merchants can choose to make purchase info available for download to the device database thereby fully automating the inventory update process.

The meal planning mode relies on the inventory level but weights the expiration or spoilage date values such that it is enabled to propose recipes that use inventory ingredients nearing expiration or spoilage first. Meal planning also enables a plurality of meals to be planned by creating recipes for a given meal count such that expiring or spoiling inventory ingredients are used in the order of which ingredients will expire or spoil first. A decrease in food inventory occurs when a recipe is selected such that one or more than one selected recipes cause inventory levels for those recipe ingredients to decrease according to recipe quantities. Meal planning mode will alert to foodstocks that need to be removed from the freezer for thawing prior to preparation based on previous menu planning If the system detects a food shortage for a planned meal, it will alert you (text, email, display) that you need to obtain a particular food item or items or it will offer you an alternative recipe that you can prepare based on food inventory on hand. User can choose to auto order the items(s) based on the need using a smart phone application that will place an order with the grocery store online for delivery or pick up.

In embodiments utilizing a weighted value for a particular food item, a value can be calculated using an expiration date as entered, subtracting from that date the current date, thus producing a value in the form of the number of days until expiration. This is “formula 1” in FIG. 1. In such a design the lower the value associated with a food item the closer it is to expiration, the more preference it will be given in recipe selection under meal planning mode.

The chart above in FIGS. 1-3 shows the basic algorithm whereby input data is incorporated into the disclosed system and categorized. However the system is not limited to this organization, other embodiments for processing this data will be apparent to those skilled in the art. The basic algorithm in the chart may be embodied through a number of coding languages, that will be apparent to those skilled in the art. Common coding languages that may be used include but are not limited to HTML, javascript, PHP, C#, AJAX (Asynchronous JavaScript and XML), Perl, C, Ruby and Ruby on Rails, Java, Python, Visual Basic .Net, Microscript, HyperTalk, Objective C. Flash, XCode, C++, Silverlight, and many other not listed but apparent to those skilled in the art.

Software may be employed on a handheld device, in the form of a mobile app, or desktop software on desktop computer. Handheld devices are defined as UPC bar code scanner, cellular phones, smart phones, tablet computers, laptops, and pda's.

In certain embodiments, the functions of the system are carried out utilizing a voice interactive component, on a hand held device or a desktop computer consistent with the examples provided herein. Examples of voice interactive software that may be used in the system include but are not limited to CMU Sphinx, Julius, Kaldi, simon, iATROS, RWTH ASR, SHoUT, VoxForge, GPL, Dragon Dictate for Mac, iListen, ViaVoice, Voice Navigator, Sonic Cloud Online Speech to text services, Dragon Dictation, Dragon Search, Google Voice Search, Bing voice search, GoVivace Cloud based speech recognition, Siri Personal Assistant, MeMeMe Mobile, Shoutout, DriveSafe.ly Speech Recognition, Vlingo, Jeannie (Voice Actions) by Pannous for Android, Speaktoit Assistant for Android, Ziri Assistant Beta for Android, Microsoft Tellme for Windows Phone 7, Ask Ziggy for Windows Phone 7, fcGlobal for Terminal, Vocre, Windows Speech Recognition, VoiceAttack, VAC-Voice activated commands, Voice Finger, WSRToolkit, Trigamtech Vocola, Dragon NaturallySpeaking, Freesr Speech Recognition Software, SpeechGear's Interact, Sonic Extractor from Digital Syphon, SpeechMagic, VoxCommando, Tazti, e-Speaking, Microsoft Speech API, Microsoft Kinect, AT&T Watson, CSLU Toolkit, Genesys Telecommunications Laboratories, HTK, iSpeech API, Freesr Speech Recognition Software, Loquendo ASR, LumenVox ASR, MIRSK ASR, Nuance Recognizer ASR, Rubidium Ltd. ASR, Proteus Conversational Interface, Simmortel Voice, Parlance nameConnector, Verbyx Inc, and others apparent to those skilled in the art.

Keyboard means may employ a physical key pad commonly used on cellular phones or laptop computers, graphical touch enabled keyboard means on a display screen, and physical keyboards connected to a computer or handheld device through a data port such as a usb port, as is often employed in computing devices, handheld, desktop, or otherwise.

As stated, the inventory system is maintained in particular embodiments by scanning a UPC code found on many food items or packaging available today or via manual or voice activated entry using a product number or descriptor such as “apple” and then quantity, and other modes of automation such as image capture, sending the image to a remote server for image-processing based analysis with image processing software. Image processing software may be employed to analyze an image of a barcode, or an image of a hand written or stamped expiration date. Processing of data may occur locally on the local device, or on the remote server. Data entered on a local device in the form of a voice recording, captured image, or entered text, can be sent over a network (satelite, wifi, bluetooth, cable and internet, cellular, etc) to a remote server. Data, once processed and organized according to the design of the current invention, may then be sent to a number of different locations including a display screen associated with the remote server, or to the original local device or another device to be displayed or otherwise communicated to the user. A mobile app may be utilized to capture a picture, send over a network to a remote server where it is processed and sends back data regarding expiration time or food item quantity and other elements consistent with the disclosure.

Food items categorized as “refrigerator”, refer to those food items that are stored in cooler temperatures associated with common household refrigerators. Food items categorized as “freezer” refer to those food items that are stored at temperatures sufficient to keep the food item frozen. Food items categorized as “pantry” refer to those food items that are safely stored at room temperature consistent with storage in the common household pantry.

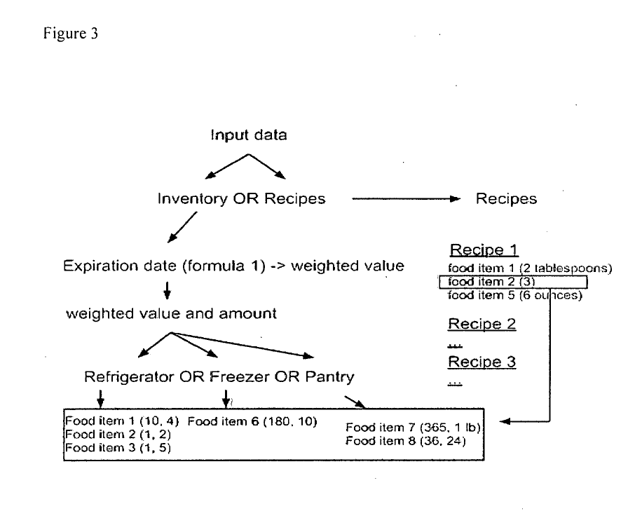

Recipes are stored in the database (as described located either locally on a device or over a network on a remote server) after either being entered manually by a user, or by extracting recipes from other databases, such as personal recipe collections or others available online or otherwise publicly disclosed. Food items in the recipes are identifiable by the software and are correlated with the same food item in the inventory, when present. See FIGS. 2 and 3. This correlation provides the basis for suggesting recipes that use soon to expire food items, as well as alerting the user when a selected recipe contains a food item or items that need to be thawed first, as described in the meal planning mode.

When generating recipes, recipes chosen from the recipes list are chosen in order of a preference, created by the recipes ingredients which are associated with the ingredients that are in the food inventory (refrigerator, freezer, or pantry), whereby the shorter expiration periods of ingredients in the inventory are selected before longer expiration periods, enabling the selection of recipes that use ingredients closer to expiration. This preferential selection enables the meal planning mode and it's advantages.

A suggested recipe, or a selected one, in certain embodiments will have an option asking “confirm recipe and reflect in inventory?” or a similarly designed choice which when selected will perform the function of lowering the inventory of the recipes ingredients according to the amount listed in the recipe, multiplied by the number of servings. In this embodiment the software identifies ingredients common to both the inventory and the selected recipe as in FIG. 3, and when confirmed by the user lowers the amount of the food item in inventory and stores the new count to the database.

In one embodiment, purchase data from the merchant is adapted either at the merchant and sent to a remote server or the user's device, or adapted on the user's device itself, such that the data is suitably formatted to be entered into the software and then recorded within the appropriate categories and accounts. Purchase data may include type of food item purchased, the amount of the item, and the expiration date and other pertinent information.

A centralized database on a remote server utilizes the advantages of “cloud computing”, organizing and storing the data according to the parameters disclosed herein, while the local device sends messages to the remote server after tagging items as purchased, entering expiration dates, selecting a recipe and correlating the ingredients with the inventory, and creating shopping lists to tag as pending and then notes increases when purchased, and other demarcations consistent with the disclosure herein.

The system also enables the collection of a large amount of data on a users diet. By tracking and analyzing the food products purchased, and recipes used, dietary information is collected and stored in the database for analysis and recommendations. For example by tracking dietary habits you can then select meals, recipes, and food items to effect a certain dietary goal. In one example, the system by tracking the dietary information and the user selecting a “low salt mode” will preferentially select food items and recipes that effectuate a low salt intake. The system enables any dietary component to selected, and multiple components can be emphasized at once. For example recipe recommendations low in salt and low in fat. In these embodiments the overall system functions as a total dietary regulator and recording instrument. In other embodiments, a diet tracking component of the software is utilized where information is entered about meals eaten out to add to the data in the system that was collected by food purchases and meal preparations.

Other health indicators may be used to select a diet consistent with improving those health indicators. For example medical or personal health data may be entered into the system, and as a result of high blood pressure, low sodium meal preparations and shopping list recommendations will be preferentially selected and recommended. These embodiments are particularly useful for managing dietary health issues such as diabetes, and other examples. These dietary considerations in the system in many embodiments are carried out according to the same modes shown herein and based on current inventory and shopping list recommendations. Numerous categories can be added to the embodiments shown in FIGS. 1-3 to enable further parameters for organizing data and recommending recipes and shopping lists.

Based on the database and usage meta data, the device will perform Diet Analysis to determine healthier options for meals. As stated, the system will suggest food substitutions targeted at specific nutritional effects. Examples of these dietary criteria include but are not limited to a lower sodium diet, lower fat, less sugar, diets rich in nutrients or a particular nutrient or vitamin, gluten free diets, high anti-oxidant diets, organic food based diets, diets promoting weight loss, diabetic, vegan or vegetarian, fish based diets, protein heavy diets, carbohydrate free diets, carbo-loading diets, locally grown food based diets, anti-aging diets, diets low in saturated fats, low in polyunsaturated fats, low cholesterol diets, family dinners, regional or cultural diets (Italian food, kosher meals, etc), allergy sensitive diets, and many others not listed but apparent to one skilled in the art. In these embodiments the system suggests recipes to support specific nutritional or dietary needs, according to each recipes dietary criteria.

In some embodiments, a central database on a remote server can store user entered recipes and tags to grow the knowledge of the database, utilizing open source editing and tagging by it's community of users.

The previous is a detailed description of embodiments of the present invention. As these embodiments of the present invention are described, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, the description is not to be considered in a limiting sense, as it is understood that the present invention is in no way limited to the embodiments described.

What is claimed:

1. A food inventory system comprising:
a microprocessor connected to a data storage device;
means for entry and removal of food items or recipes;
means for display;
assigning a food item a weighted value correlated with the time until food spoilage for said food item;
categorizing each food item entered as refrigerator, freezer, or pantry.

2. The food inventory system of claim 1, further comprising means for entry and removal of food items by either manual entry, bar code scanning, or voice interactive software.

3. The food inventory system of claim 1, further comprising means for entry of food items and the food items expiration date by either image capture and analysis or bar code scanning

4. A method of generating a shopping list based on current food inventory levels comprising the system of claim 1, wherein food items are placed into a list according to either their weighted values such that expired food items or soon to expire food items are preferentially selected, or their food item amount such that food items in amounts close to or equal to zero are preferentially selected.

5. A method of meal planning comprising the system of claim 1, wherein the system preferentially selects recipes according to the shortest time to expiration of the food items in said recipe based upon the food items weighted value.

6. A method of maintaining food inventory comprising the generation of shopping lists according to claim 4 and the meal planning of claim 5.

7. Maintaining a food inventory according to claim 6 carried out on a handheld computing device.

8. The method of claim 5, wherein a recipe containing a food item categorized as “freezer” initiates a message on the display, or a message sent via text message, or a message sent via email.

9. The method of claim 5, further comprising lowering the amount of the food item in the inventory by the amount used in a selected recipe.

10. The method of claim 5, whereby data is collected on a local device and sent over a network to a remote server where said data is processed and returned over the network to the local device.

11. The method of claim 5, whereby data on food item name, quantity, and expiration date is collected by a merchant and sent to a remote device for processing.

12. Claim 11, wherein the remote device stores the data in a database.

13. Claim 4, further comprising sending the shopping list to a merchant to automatically fulfill an order comprised of the items on the shopping list.

12. Claim 10, wherein the processing on a remote server includes analysis of a voice recording by voice interactive software or image analysis by image processing software.

13. Claim 4, further comprising items on the list being highlighted, bolded, colored, or flashing on the display in order of their date of expiration.

14. Claim 4, further comprises sending the selected information to a device via email or text message.

15. Claim 5, further comprising selecting recipes based upon dietary criteria.
